(19) United States
(12) Patent Application Publication
(10) Pub. No.: US 2020/0148178 A1
(43) Pub. Date: May 14, 2020

(54) Brake Pedal Actuation Device and Method of Use

(71) Applicant: Todd Teeters, Othello, WA (US)

(72) Inventor: Todd Teeters, Othello, WA (US)

(21) Appl. No.: 16/678,090

(22) Filed: Nov. 8, 2019

Related U.S. Application Data
(60) Provisional application No. 62/757,885, filed on Nov. 9, 2018.

(51) Int. Cl. B60T 7/10; B60T 7/04; B60T 7/06

(52) U.S. Cl. CPC B60T 7/101; B60T 7/06; B60T 7/047

(57) ABSTRACT

A brake pedal actuation device. The brake pedal actuation device includes an elongated body having a first end opposite a second end, wherein the elongated body includes a first portion slidably disposed over a second portion such that the elongated body is movable between a collapsed position and an extended position. A linear distance between the first end and the second end is greater when in the extended position. A handle is removably secured to the first portion via friction fit.

### CROSS REFERENCE TO RELATED APPLICATIONS

This application claims the benefit of U.S. Provisional Application No. 62/757,885 filed on Nov. 9, 2018. The above identified patent application is herein incorporated by reference in its entirety to provide continuity of disclosure.

### BACKGROUND OF THE INVENTION

The present invention relates to brake pedal actuation devices. More particularly, the present invention pertains to a brake pedal actuation device comprising a telescopic elongated rod, wherein a handle is removably secured to a first portion of the elongated rod.

Proper brake light operation is a legal requirement in most, if not all, states. In order to satisfy these requirements, the brake lights must properly respond and illuminate upon depression of the brake pedal, such that other drivers are informed of the driver's decreasing speed. Unfortunately, it is not possible for a driver to exit the vehicle to verify that the brake lights are properly functioning when the brake pedal is depressed. Often, it requires the assistance of an additional person, such that one person depresses the brake pedal, while the second examines the brake lights to ensure the lights are illuminating properly. As with any activity that requires additional assistance, it can be impractical or inconvenient to complete even a simple task. Alternatively, many prop up a weight or other device to maintain the brake pedal in a depressed state while examining the brake lights, however this can be time consuming or difficult to manage, especially when the user must assemble, find, or otherwise jury-rig a device to perform the task. Therefore, a device that can readily depress a brake pedal allowing a user to exit the vehicle to investigate the vehicle's brake lights is desired.

In light of the devices disclosed in the known art, it is submitted that the present invention substantially diverges in design elements from the known art and consequently it is clear that there is a need in the art for an improvement to existing brake pedal actuation device. In this regard, the instant invention substantially fulfills these needs.

### SUMMARY OF THE INVENTION

In view of the foregoing disadvantages inherent in the known types of brake pedal actuation devices now present in the known art, the present invention provides a brake pedal actuation device wherein the same can be utilized for providing convenience for the user when testing the brake lights of a vehicle.

The present device comprises an elongated body having a first end opposite a second end, wherein the elongated body further comprises a first portion slidably disposed over a second portion, such that the elongated body is configured to selectively move between an extended position and a collapsed position. A linear distance between the first end and the second end is greater when the elongated body is in the extended position than in the collapsed position. A handle is further removably secured to the first portion via friction fit. In some embodiments, the device further comprises a pair of stoppers, wherein a stopper of the pair of stoppers is disposed on each of the first and second ends of the elongated device. In another embodiment, the pair of stoppers taper radially inward from a distal end thereof towards a proximal end thereof. In this way, each stopper of the pair of stoppers have a greater surface area at the distal end thereof for engaging a support surface, such as a brake pedal.

In other embodiments, the handle comprises a planer member having a pair of legs extending orthogonally from opposing ends thereof. In yet another embodiment, a cutout is disposed through each of the pair of legs, wherein the cutout is dimensioned to receive the first portion therein. In this way, the handle is removably securable to the first portion, allowing the user to disassemble the device for storage. In some embodiments, the cutout is defined between a pair of projections, wherein the pair of projections are biased towards a longitudinal axis of the pair of legs, thereby allowing the pair of projections to grip about the first portion. In another embodiment, the pair of projections taper outwards, such that a width of the pair of projections is greater at a far end thereof. Thus, the pair of projections are more securely affixed about the first portion.

In some embodiments, a plurality of apertures is disposed through the first portion, wherein a ball decent locking mechanism disposed within the second portion is configured to engage one of the plurality of apertures. In this way, the elongated body can be secured at a desired length. In another embodiment, the plurality of apertures is disposed along a length of the first portion at regular intervals.

The method comprises providing an elongated body having a first end opposite a second end, wherein the elongated body is telescopically adjustable in length via a plurality of apertures configured to engage a ball detent locking mechanism to secure the elongated body at a desired length, placing the first end against a brake pedal of a vehicle, disengaging the ball detent locking mechanism from one of the plurality of apertures, extending the elongated body to a desired length, such that the second end is in contact with a support surface and the brake pedal is depressed, and observing each brake light of the vehicle to determine whether the brake lights are functioning. In some embodiments, the method further comprises affixing a handle comprising a planar member having a pair of legs removably securable about the elongated body thereto. In another embodiment, the method further comprises grasping the handle to extend the elongated body to a desired length.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective view of an embodiment of the brake pedal actuation device in a collapsed position.

FIG. 1B shows a perspective view of an embodiment of the brake pedal actuation device in an extended position.

FIG. 2 shows a perspective view of the handle of an embodiment of the brake pedal actuation device.

FIG. 3 shows a side view of an embodiment of the brake pedal actuation device in use.

### DETAILED DESCRIPTION OF THE INVENTION

Reference is made herein to the attached drawings. Like reference numerals are used throughout the drawings to depict like or similar elements of the brake pedal actuation device. The figures are intended for representative purposes only and should not be considered to be limiting in any respect.

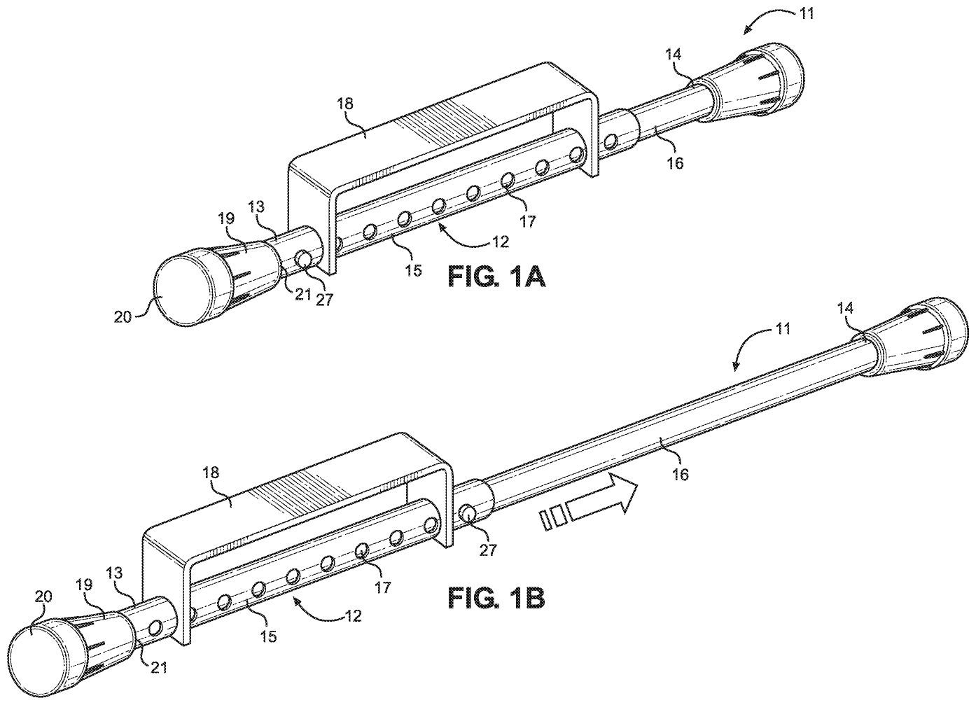

Referring now to FIGS. 1A and 1B, there is shown a perspective view of an embodiment of the brake pedal actuation device in a collapsed position and a perspective view of an embodiment of the brake pedal actuation device in an extended position, respectively. The brake pedal actuation device 11 comprises an elongated body 12 having a first end 13 opposite a second end 14. The elongated body 12 further comprises a first portion 15 slidably disposed over a second portion 16, such that the elongated body 12 can be selectively moved between an extended position (as shown in FIG. 1B) and a collapsed position (as shown in FIG. 1A). A linear distance between the first end 13 and the second end 14 is greater when elongated body 12 is in the extended position than when in the collapsed position. In some embodiments, the first portion 15 is dimensioned such that frictional forces between the first portion 15 and the second portion 16 are configured to retain the elongated body 12 at a desired length. In this way, once the user sets the elongated body 12 at the desired length, the elongated body 12 retains that length until sufficient external forces are applied to the elongated body 12 to increase or decrease the length thereof.

In the shown embodiment the elongated body 12 further comprises plurality of apertures 17 through the first portion 15, wherein a ball-detent locking mechanism 27 disposed within the second portion 16 is configured to engage one of the plurality of apertures 17 to retain the elongated body 12 at a desired length. The ball-detent locking mechanism 27 is spring-biased towards an outward position and is configured to depress within an interior of the second portion 16. In this way, the ball-detent locking mechanism 27 can allow the first portion 15 to freely slide along the second portion 16 until one of the plurality of apertures 17 overlaps the ball-detent locking mechanism 27, at which point the ball-detent locking mechanism 27 extends through one of the plurality of apertures 17 to lock the elongated body 12 at a desired length. In the illustrated embodiment, the plurality of apertures 17 are evenly and linearly disposed along a length of the first portion 15, thereby providing the user with a variety of length options for the elongated body 12.

In the illustrated embodiment, a stopper of a pair of stoppers 19 is disposed on each of the first and second ends 13, 14 of the elongated body 12. In some embodiments, the pair of stoppers 19 comprise a compressible material allowing the pair of stoppers 19 to conform to a support surface, such as a brake pedal or vehicle seat. In other embodiments, the pair of stoppers 19 further comprise a material providing a coefficient of friction greater than one, such as rubber or the like. In this way, the user is ensured that the elongated body 12 is secured between a pair of support surfaces and remains in position when placed. In the illustrated embodiment, the pair of stoppers 19 taper radially inward from a distal end 20 thereof towards a proximal end 21 thereof. In this way, an outer surface disposed at the distal end 20 comprises a greater surface area for frictional engagement against the support surface. In this way, the distal end 20 comprises a greater width than the elongated body 12.

A handle 18 is removably securable to the first portion 15 of the elongated body 12, wherein the handle 18 is configured to provide the user with a gripping surface. In the shown embodiment, the handle 18 defines a substantially rectangular opening allowing the user to insert a hand therethrough. The handle 18 can be grasped to provide increased control of the elongated body 12 when placing, securing, and extending the elongated body 12 within a vehicle. The handle 18 is removably secured to the elongated body 12, such that the user can

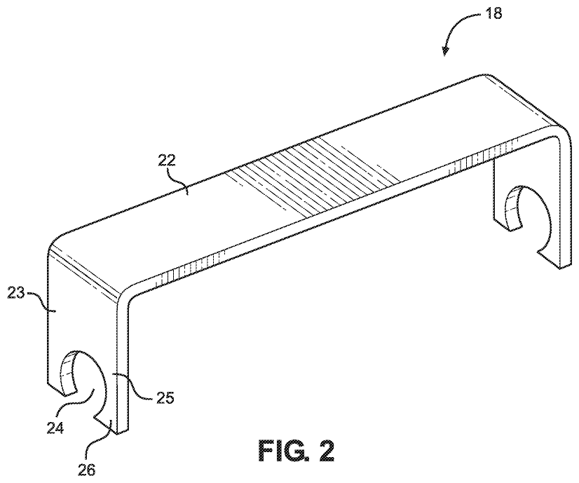

Referring now to FIG. 2, there is shown a perspective view of the handle of an embodiment of the brake pedal actuation device. In the illustrated embodiment, the handle 18 comprises a planar member 22 having a pair of legs 23 extending orthogonally therefrom at opposing ends thereof. The pair of legs 23 can comprise a variety of lengths, such a greater void space between the planar member 22 and the elongated body is defined thereby, thereby accommodating users having hands of various sizes. In the shown embodiment, a cutout 24 is disposed through each of the pair of legs 23, wherein the cutout 24 is dimensioned to receive the first portion of the elongated body therein. In this way, the handle 18 is securable to the first portion.

In the illustrated embodiment, the cutout 24 is defined by a pair of protrusions 25, wherein an interior portion of the pair of protrusions 25 is arcuate to conform to the first portion. In some embodiments, the pair of protrusions 25 are biased towards a longitudinal axis of the pair of legs 23, such that the pair of protrusions 25 grip about the elongated body when the handle 18 is secured thereto. In some such embodiments, the pair of protrusions 25 are flexible and comprise a high friction material to prevent the handle 18 from sliding along the elongated body when secured thereto. In this way, the user can easily manipulate the elongated body between the extended position and the collapsed position. In the illustrated embodiment, the pair of protrusions 25 taper outwards at a far end 26 thereof, such that the cutout 24 defined thereby can further encircle the elongated body. In this way, a greater surface area of the handle 18 is in contact with the elongated body, further securing the handle 18 thereto.

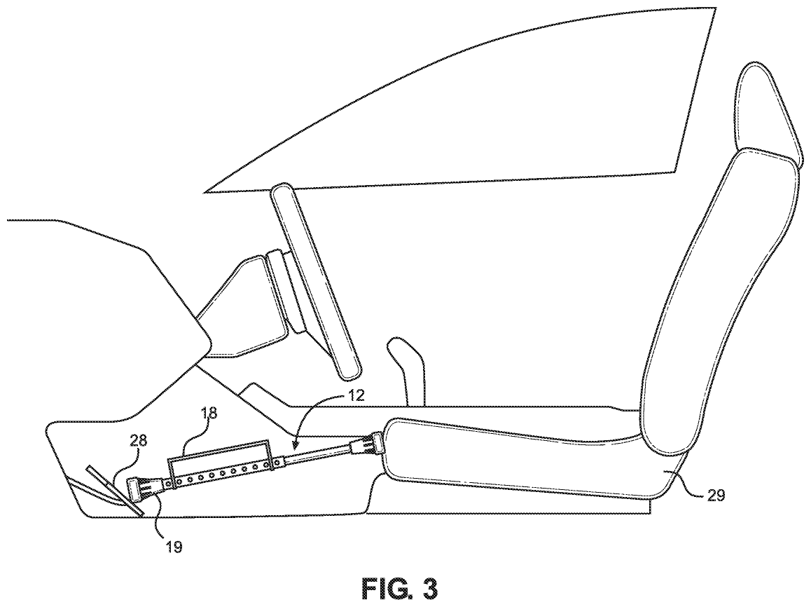

Referring now to FIG. 3, there is shown a side view of an embodiment of the brake pedal actuation device in use. In one exemplary use, the user places the first end of the elongated body 12 against a support surface, such as a brake pedal 28. In some embodiments, the first end is secured thereagainst via frictional engagement with one of the pair of stoppers. The user can then extend the elongated body 12 such that the second end of the elongated body 12 is then placed against an opposing support surface, such as a vehicle seat 29. In some embodiments, the user must disengage the ball-detent locking mechanism from the plurality of apertures to adjust the length of the elongated body 12, such that the elongated body 12 makes simultaneous contact with both the brake pedal 28 and the vehicle seat 29. Once the elongated body 12 is extended such that the brake pedal 28 is fully depressed and the elongated body 12 is supported fully between the brake pedal 28 and the vehicle seat 29, the user can exit the vehicle and observe each brake light of the vehicle to determine whether the brake lights are properly illuminated when the brake pedal 28 is depressed.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A brake pedal actuation device, comprising:
an elongated body having a first end opposite a second end;
wherein the elongated body further comprises a first portion slidably disposed over a second portion, such that the elongated body is configured to selectively move between an extended position and a collapsed position;
wherein a linear distance between the first end and the second end is greater when the elongated body is in the extended position than in the collapsed position;
a handle removably secured to the first portion via friction fit.

2. The brake pedal actuation device of claim 1, further comprising a pair of stoppers, wherein a stopper of the pair of stoppers is disposed on each of the first and second ends of the elongated body.

3. The brake pedal actuation device of claim 2, wherein each of the pair of stoppers taper radially inward from a distal end thereof towards a proximal end thereof.

4. The brake pedal actuation device of claim 1, wherein the handle comprises a planar member having a pair of legs extending orthogonally from opposing ends thereof.

5. The brake pedal actuation device of claim 4, further comprising a cutout through each of the pair of legs, the cutout dimensioned to receive the first portion therein.

6. The brake pedal actuation device of claim 5, wherein the cutout is defined between a pair of projections the pair of projections biased towards a longitudinal axis of each of the pair of legs.

7. The brake pedal actuation device of claim 6, wherein the pair of projections taper outwards, such that a width of the projection is greater at a far end thereof.

8. A brake pedal actuation device comprising:
an elongated body having a first end opposite a second end;
wherein the elongated body further comprises a first portion slidably disposed over a second portion, such that the elongated body is configured to selectively move between an extended position and a collapsed position;
wherein a linear distance between the first end and the second end is greater when the elongated body is in the extended position than in the collapsed position;
a plurality of apertures through the first portion;
a ball-detent locking mechanism disposed on the second portion and configured to engage one of the plurality of apertures such that the elongated body is secured at a desired length;
a handle removably secured to the first portion via friction fit.

9. The brake pedal actuation device of claim 8, wherein the plurality of apertures is disposed along a length of the first portion at regular intervals.

10. The brake pedal actuation device of claim 8, wherein the plurality of apertures is disposed linearly along the first portion.

11. The brake pedal actuation device of claim 8, further comprising a pair of stoppers, wherein a stopper of the pair of stoppers is disposed on each of the first and second ends of the elongated body.

12. The brake pedal actuation device of claim 11, wherein each of the pair of stoppers taper radially inward from a distal end thereof towards a proximal end thereof.

13. The brake pedal actuation device of claim 8, wherein the handle comprises a planar member having a pair of legs extending orthogonally from opposing ends thereof.

14. The brake pedal actuation device of claim 13, further comprising a cutout through each of the pair of legs, the cutout dimensioned to receive the first portion therein.

15. The brake pedal actuation device of claim 14, wherein the cutout is defined between a pair of projections, the pair of projections biased towards a longitudinal axis of each of the pair of legs.

16. The brake pedal actuation device of claim 15, wherein the pair of projections taper outwards, such that a width of the projection is greater at a far end thereof.

17. A method of using a brake pedal actuation device, comprising:
providing an elongated body having a first end opposite a second end wherein the elongated body is telescopically adjustable in length via a plurality of apertures configured to engage a ball-detent locking mechanism to secure the elongated body at a desired length;
placing the first end against a brake pedal of a vehicle;
disengaging the ball-detent locking mechanism from one of the plurality of apertures;
extending the elongated body to a desired length, such that the second end is in contact with a support surface and the brake pedal is depressed;
observing each brake light of the vehicle to determine whether the brake lights are functioning.

18. The method of claim 17, further comprising affixing a handle comprising a planar member having a pair of legs removably securable about the elongated body thereto.

19. The method of claim 18, further comprising grasping the handle to extend the elongated body to a desired length.
